(19) United States
(12) Patent Application Publication
(10) Pub. No.: US 2001/0019424 A1
(43) Pub. Date: Sep. 6, 2001

(54) Image-forming devices portable telephones, image-processing devices, image-processing methods, and computer program product

(76) Inventor: Takenori Idehara, Tokyo (JP)

Correspondence Address: BURNS DOANE SWECKER & MATHIS L L P, POST OFFICE BOX 1404, ALEXANDRIA, VA, 22313-1404, US

(21) Appl. No.: 09/796,443

(22) Filed: Mar. 2, 2001

(30) Foreign Application Priority Data
Mar. 6, 2000 (JP) 2000-60655
Mar. 6, 2000 (JP) 2000-60656

(51) Int. Cl. B41B 1/00

(52) U.S. Cl. 358/1.15

(57) ABSTRACT

The invention relates to an image-forming device. The image-forming device based on this invention comprises a receiving unit for receiving image data that correspond to multiple images and information indicating the relation between the images from a portable telephone; an image-processing unit for disposing the multiple images based on the received information; and a printing unit for printing the images disposed by the image-processing unit. Said image-forming device allows the user to see multiple images simultaneously by means of disposing and printing the multiple images simultaneously.

This application is based on Japanese Patent Application Nos. 2000-60655 and 2000-60656 filed on Mar. 6, 2000, the contents of which are hereby incorporated by reference.

### BACKGROUND OF THE INVENTION

1. Field of the Invention

The invention relates to image-forming devices, portable telephones, image-processing devices, image-processing methods, and computer program product.

2. Description of the Prior Arts

Some of the portable telephones currently available on the market are capable of receiving via networks such as the Internet, processing and displaying images.

However, the amount of information that can be displayed is limited because the display area of such a portable telephone is limited. Therefore, a menu called a hierarchical menu, where a certain hierarchy is introduced in order to compensate for the smallness of the quantity of information that can be displayed on the display device.

In the hierarchical menu, when the user selects an item from a list of multiple choices consisting of multiple items, an image that corresponds to an item of a lower hierarchical level will be displayed based on the correlating information of the choices provided to indicate the hierarchical relations. Thus, the user can successively view images located on different levels by following the hierarchical menus of different levels. However, the user cannot see the images on different levels all at once in such a display system using the hierarchical menus.

### SUMMARY OF THE INVENTION

The object of the invention is to provide to image-forming devices, portable telephones, image-processing devices, image-processing methods, and computer program product for seeing images on different levels all at once.

An image-forming device based on this invention comprises a receiving unit for receiving image data that correspond to multiple images and information indicating the relation between the images from a portable telephone; an image-processing unit for disposing the multiple images based on the received information; and a printing unit for printing the images disposed by the image-processing unit. Said image-forming device allows the user to see multiple images simultaneously by disposing and printing the multiple images simultaneously.

Furthermore, a portable telephone based on this invention comprises a memory unit for storing image data that correspond to multiple images and information indicating the relation between the images and an output unit for outputting the multiple images and the relation between the images that are stored. Said portable telephone can output the multiple image data and the relation between the images.

Furthermore, an image-processing device based on this invention comprises a receiving unit for receiving multiple images and information indicating the relation between the images from a portable telephone; an image-processing unit for disposing the multiple images based on the received information; and an output unit for outputting image data that correspond to the images disposed by said image processing unit. Said image-processing device can dispose multiple images based on the received information and output the image data that correspond to the disposed images.

Furthermore, an image processing method based on this invention comprises a step for receiving multiple images and information indicating the relation between the images from a portable telephone; a step for disposing the multiple images based on the received information; and a step for outputting image data that correspond to the disposed images. Said image processing method can dispose multiple images based on the received information and output the image data that correspond to the disposed images.

Furthermore, another image processing method based on this invention comprises a step for receiving multiple images and information indicating the relation between the images from a portable telephone; a step for disposing the multiple images based on the received information; a step for adding line drawing images indicating the relation between the multiple images after they have been disposed; and a step for outputting image data that correspond to the disposed images and the line drawing images. Said image-processing method can dispose multiple images based on the received information, add line drawing images indicating the relation between the multiple images after they are disposed, and output the image data that correspond to the disposed images and the line drawing images.

Furthermore, a computer program product based on this invention executes a process of: receiving multiple images and information indicating the relation between the images from a portable telephone; disposing the multiple images based on the received information; and outputting image data that correspond to the disposed images. Said computer program product can dispose multiple images based on the received information and output the image data that correspond to the disposed images.

### BRIEF DESCRIPTION OF THE DRAWINGS

FIG. 1 is a schematic drawing of an information capturing system comprising an image-forming device and a portable telephone.

FIG. 2 is a block diagram indicating the composition of the portable telephone.

FIG. 3 shows an example image displayed on the display device.

FIG. 4 is a conceptual diagram indicating the hierarchy of the images to be displayed.

FIG. 5 is a block diagram indicating the composition of the image-forming device.

FIG. 6 is a flow chart indicating the process performed inside the portable telephone when images are transmitted.

FIG. 7 is a flow chart indicating the image disposing process performed inside the image-forming device.

FIG. 8 shows an example of the images disposed inside an image disposition RAM.

FIG. 9 is an example of image disposition where images are disposed in a horizontal direction in the order of higher hierarchies.

FIG. 10 is an example of image disposition where images are disposed in a horizontal direction in the order of higher hierarchies.

FIG. 11 is an example of image disposition where images are disposed in a vertical direction in the order of higher hierarchies.

FIG. 12 is a flow chart indicating the process performed inside the portable telephone when images are transmitted.

FIG. 13 is a flow chart indicating the image disposing process performed inside the image-forming device.

FIG. 14 is a flow chart continuing from FIG. 13.

FIG. 15 is a block diagram indicating the composition of the portable telephone.

FIG. 16 is a flow chart indicating the process performed inside the portable telephone.

FIG. 17A is a flow chart indicating the process performed inside the portable telephone.

FIG. 17B is a flow chart continuing from FIG. 17A.

FIG. 18 is a flow chart continuing from FIG. 17A.

FIG. 19 is a flow chart continuing from FIG. 18.

### DETAILED DESCRIPTION OF THE INVENTION

Preferred embodiments of the present invention will be described in the following referring to the accompanying drawings.

(Embodiment 1)

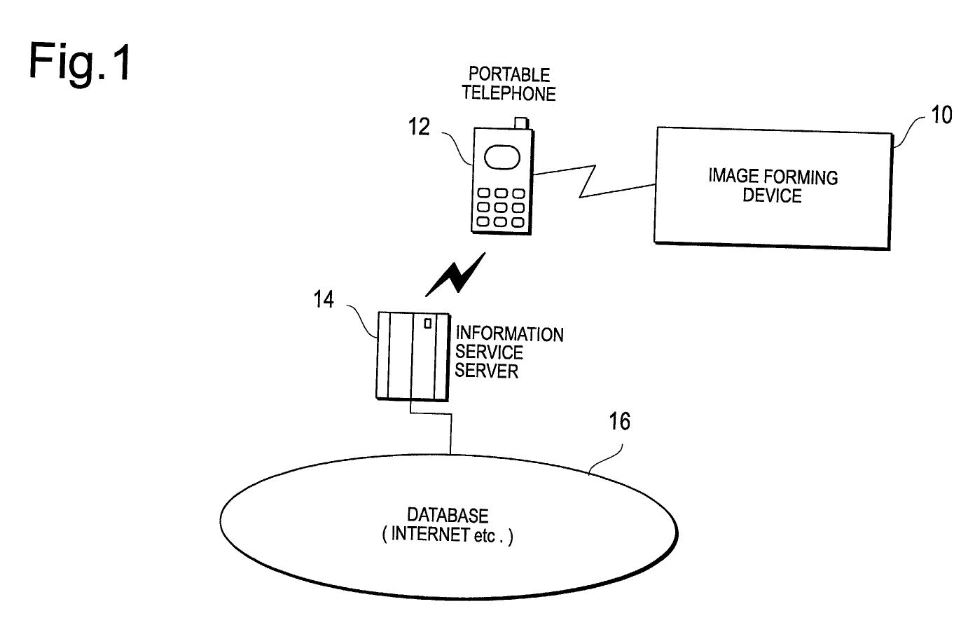

FIG. 1 is a schematic drawing of an information capturing system comprising an image-forming device and a portable telephone.

This information capturing system consists of an image-forming device 10, a portable telephone 12, an information service server 14 and a database 16. The image-forming device 10 is, for example, a printer, copying machine, facsimile machine, etc. The portable telephone is a device that allows the user to view a display using a hierarchical menu.

The portable telephone 12 receives via an information server 14 image data that correspond to images and image link information that indicate hierarchical relations with other images from a database 16 that is accessible through a network such as the Internet.

The portable telephone 12 converts the image data and the image link information into data format that can be processed by the image-forming device 10 respectively (e.g., a data format expressed in a page descriptive language in case of image data) and transmits them to the image-forming device 10 by wired or wireless means. The communication between the image-forming device 10 and the portable telephone 12 can be done by means of wireless means such as infrared rays or electromagnetic waves, or by wired means using USB, IEEE 1394, or IEEE 1284.

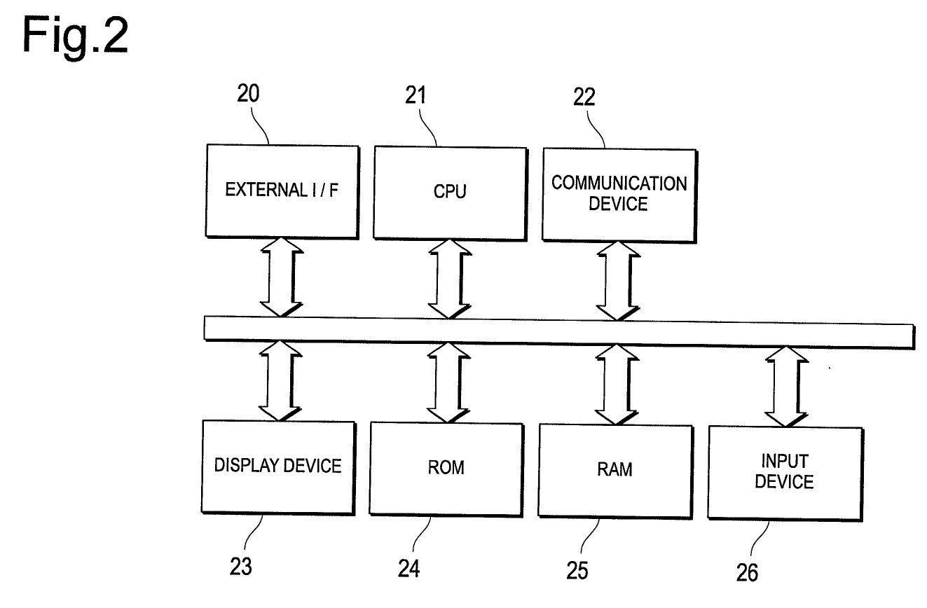

FIG. 2 is a block diagram indicating the composition of the portable telephone 12.

The portable telephone 12 comprises an external interface (I/F) 20, a CPU 21, a communication device 22, a display device 23, a ROM 24, a RAM 25 and an input device 26.

The external interface 20 is used to connect the portable telephone 12 with the image-forming device 10 and other external peripheral equipment to exchange data between them. The CPU 21 is in charge of overall control of various devices That constitute the portable telephone 12. The communication device 22 receives image data that correspond to images and image link information from the database 16 by accessing the information service server 14. The display device 23 displays images based on image data received from the database 16.

The ROM 24 stores the control program of the portable telephone 12 and the conversion table for converting image data and image link information into data formats that can be processed by the image-forming device. The RAM 25 stores the images and the image link information received by the communication device 22. The input device 26 has multiple operating pushbuttons for the user to operate the portable telephone 12.

When the user wishes to receive image data from the database 16, the user selects an image that the user wishes to receive at the input device 26 while monitoring the display of the display device 23. Based on this selection, the CPU 21 controls the communication device 22 to receive an image data that corresponds to the image and the image link information from the database 16. The received image data and the image link information are stored in the RAM 25 sequentially. The image based on the received image data will be displayed on the display device 23.

Let us now describe a specific example of image display by the display device 23 of the portable telephone 12.

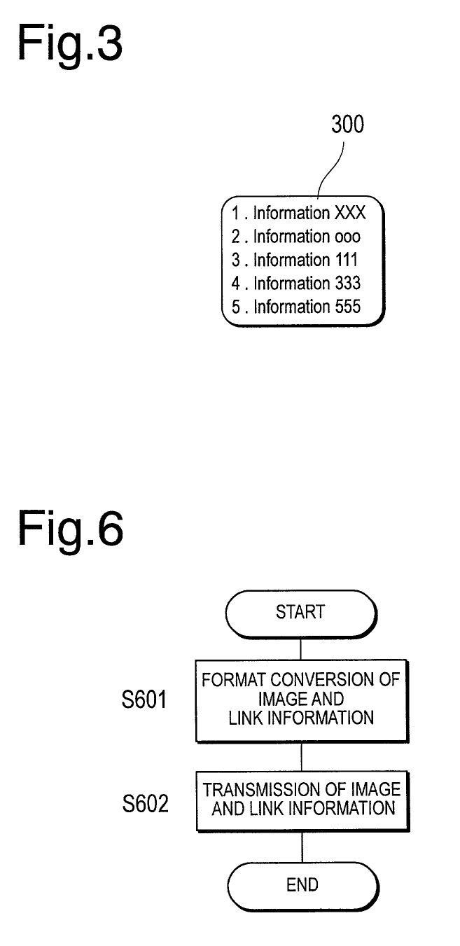

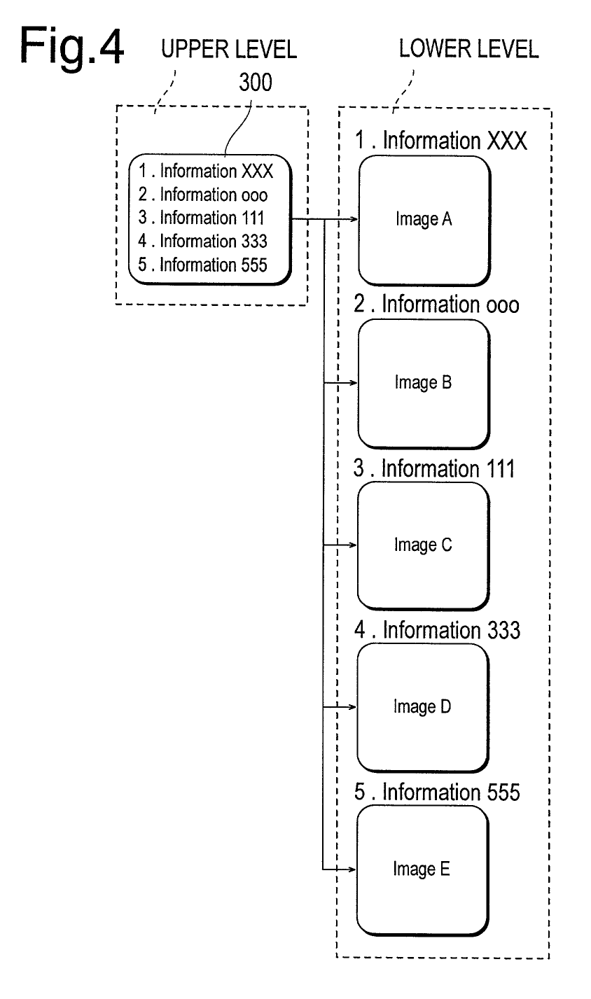

FIG. 3 shows an example image displayed on the display device 23. FIG. 4 is a conceptual diagram indicating the hierarchical level of the images to be displayed.

An image is displayed for the entire width of the portable telephone 12's screen as shown in FIG. 3.

When the user selects “information XXX” on the image 300 shown in FIG. 3, an image A and image link information that corresponds to said image A are called up and the image A will be displayed based on the link information concerning the image 300. Similarly, when “information OOO” is selected, an image B and image link information that corresponds to said image B, when “information 111” is selected, an image C and image link information that corresponds to said image C, when “information 333” is selected, an image D and image link information that corresponds to said image D, and when “information 555” is selected, an image E and image link information that corresponds to said image E are called up respectively and the images A through E will be displayed on the display device 23.

The hierarchical relation of the displayed images here is such that the image 300 is located on a higher hierarchical level and the images A through E are located on a lower hierarchical level.

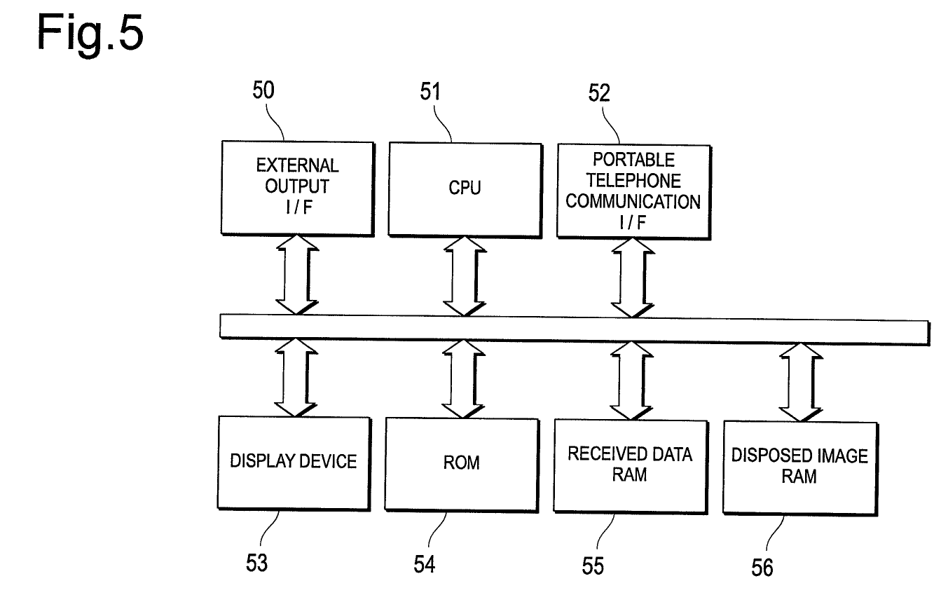

FIG. 5 shows the block diagram showing the constitution of the image-forming device 10.

The image-forming device 10 consists of an external output interface (I/F) 50, a CPU 51, a portable telephone communication interface (I/F) 52, a display device 53, a ROM 54, a received data RAM 55, and a disposed image RAM 56.

The external output interface 50 is intended for connection and data exchange between the image-forming device 10 and external equipment such as a client computer. The CPU 51 is in charge of an overall control of various devices that constitute the image-forming device 10. The portable telephone communication interface 52 is intended for connecting the portable telephone 12 with the image-forming device 10 to exchange data between them. The display device 53 is intended for displaying the setup of the image-forming device 10 and printing jobs, for example, for displaying setup screens to change printing setups using a touch-screen method.

The ROM 54 stores control programs of the image-forming device 10. The received data RAM 55 stores image data and image link information received from the portable telephone 12. The disposed image RAM 56 stores imaged at a corresponding to images disposed according to the image link information.

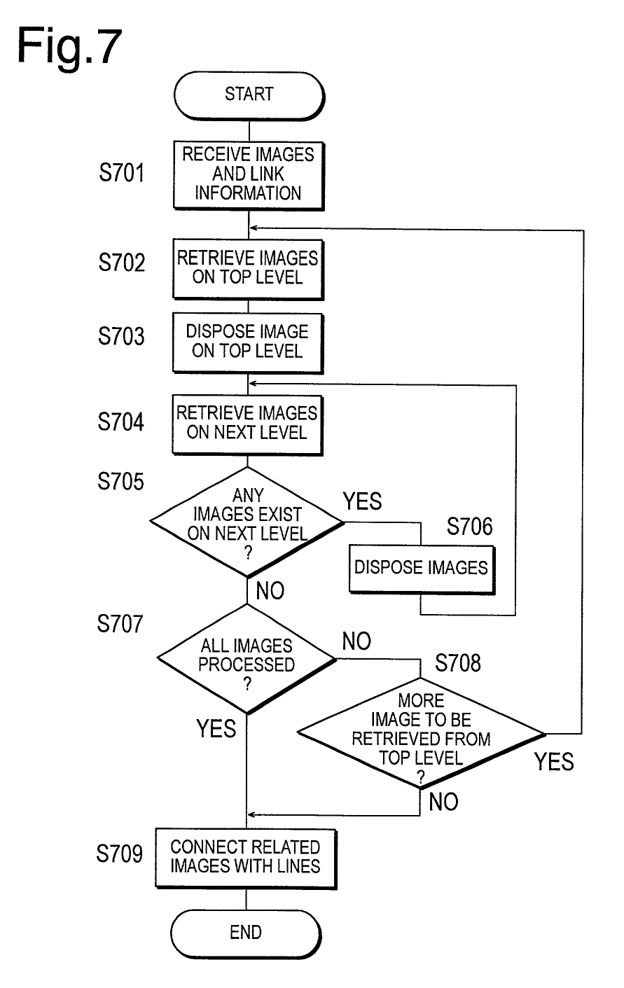

FIG. 6 is a flow chart indicating the process within the portable telephone 12 when transmitting images from the portable telephone 12 to the image-forming device 10.

The CPU 21 converts the image data and the image link information stored in the RAM 25 into data formats that can be processed by the image-forming device 10 (S601). The image data and the image link information are transmitted to the image-forming device 10 via the external interface 20 (S602).

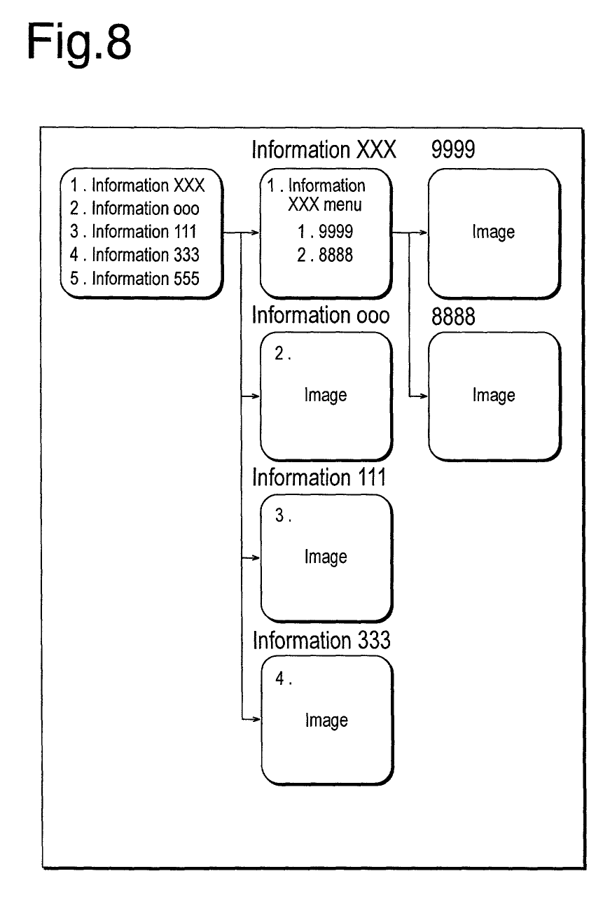

FIG. 7 is a flow chart indicating the image disposing process performed inside the image-forming device 10 that received the image data and the image link information.

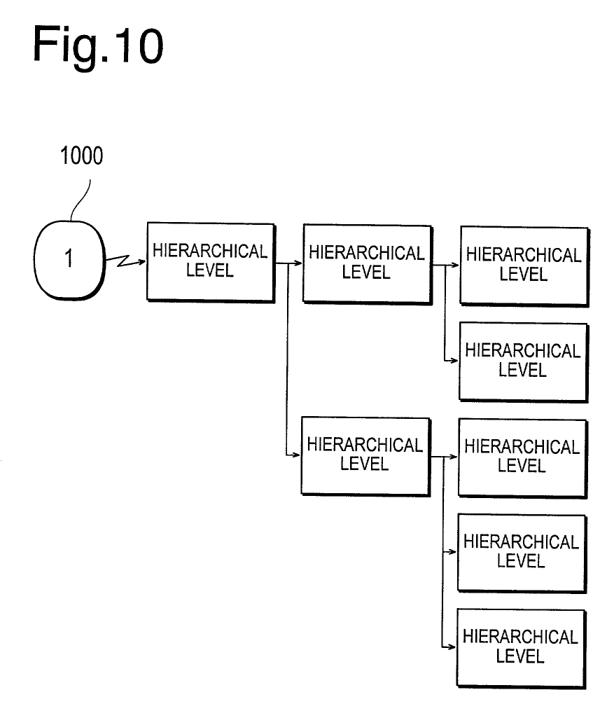

The image-forming device 10 receives image data and image link information from the portable telephone 12 and stores them in the received data RAM 55 (S701). The CPU 51 retrieves an image data corresponding to an image that is located on the highest hierarchical level among the image data stored in the received data RAM 55 based on the image data and the image link information stored in the received data RAM 55 (S702). The CPU 51 disposes the retrieved image that is located on the highest hierarchical level to a disposing location corresponding to the highest hierarchical level (e.g., the location of a block 910 shown in FIG. 9) (S703). This disposition is performed by storing the image data in the disposed image RAM 56.

When the disposition of the image on the highest hierarchical level is finished, the CPU 51 then retrieves images hierarchically related to said image located on the highest hierarchical level and located on the next level of hierarchy (S704), and makes a judgment whether there are such images on the next level of hierarchy (S705). While the system retrieves images hierarchically related to the image located on the highest hierarchical level and located on the next level of hierarchy at the step S704, it will retrieve images hierarchically related to the images located on the higher hierarchical level and located on the next level of hierarchy during the steps that follow.

If it is determined that there are image(s) on the next level of hierarchy as a result of the judgment (S705: YES), the images located on the level of hierarchy will be disposed on the location(s) that correspond to the level of hierarchy (e.g., locations of the block 920 shown in FIG. 9) (S706), and the system returns to the step S704.

On the other hand, if no image exists in the next level of hierarchy (S705: NO), a judgment is made whether the process has been completed for all the images (S707).

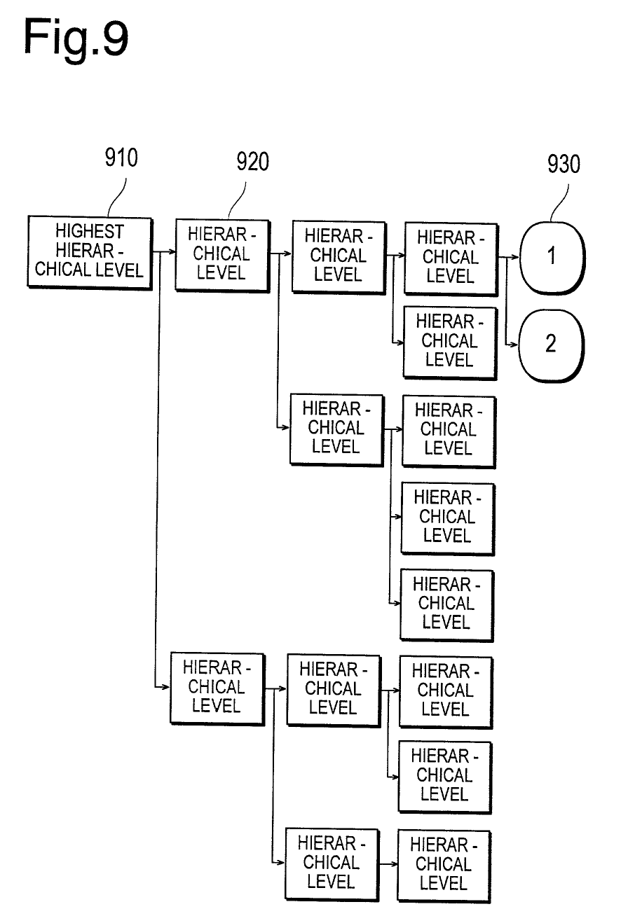

If it is determined that the process has been completed for all the images as a result of the judgment (S707: YES), those disposed images that are mutually related are connected with solid line arrows to indicate the hierarchical relations based on the image link information, and such an image of connecting lines is added to the disposed images (S709) before completing the image disposition process. The disposed images are as shown in FIG. 8.

On the other hand, if the process has not been completed for all the images (S707: NO), a judgment is made based on the image link information as to whether any images exist yet to be retrieved on the same top level of hierarchy as the image retrieved at the step S702 (S708).

If it is determined that another image exists on the same level of hierarchy as the image retrieved at the step S702 (S708: YES), the system returns to the step S702.

If it is determined that no more image exists on the same level of hierarchy as the image retrieved at the step S702 (S708: NO), the system advances to the step S709.

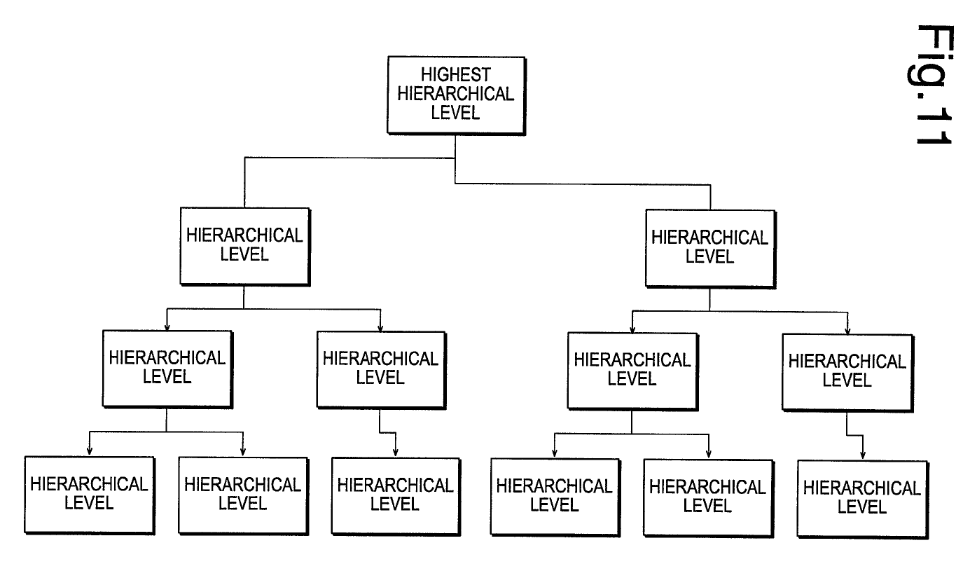

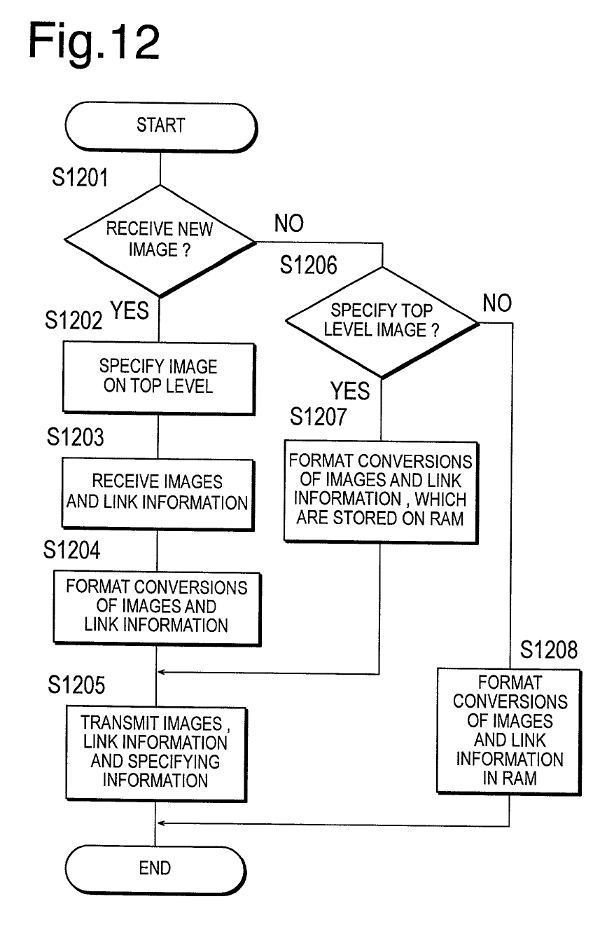

In the example image dispositions of the image-forming device 10 described above, the images of different levels of hierarchy are disposed horizontally from left to right in the order of higher hierarchies. However, the direction of image disposition can be arbitrarily chosen either horizontally or vertically. Examples of different image disposition directions are as shown in FIG. 9, FIG. 10 and FIG. 11.

FIG. 9 and FIG. 10 show examples where images of different levels of hierarchies are disposed horizontally, while FIG. 11 shows and example where images of different levels of hierarchies are disposed vertically.

When images of different levels of hierarchies are disposed horizontally as shown in FIG. 9 and FIG. 10, the image of the highest hierarchical level is located first at the leftmost position, and images of the next level of hierarchy are disposed to its right vertically, and all the rest similarly in sequence. This process of disposition is repeated in sequence until all the images in the received data RAM 55 are exhausted starting from the higher levels of hierarchy. The disposed images that are mutually related are connected with solid line arrows to indicate the hierarchical relations based on the image link information.

At the same time, the CPU 51 starts to dispose images on the next page if it determines that the next image cannot be disposed by comparing the size of the space the disposed images share as prepared by the page description language and the size of the space available on a page for image disposal. The relation between the first page and the next page can be confirmed by the blocks 930 and 1000 that are attached with connectors as shown in FIGS. 9 and 10. In other words, the blocks 930 and 1000 indicate that the images following the block 930 of FIG. 9 can be disposed after the block 1000 of FIG. 10.

FIG. 11 shows an example where the images on different levels of hierarchy are disposed in the vertical direction from the one on the highest hierarchical level.

Although the images are disposed based on the comparison between the space the disposed images share and the space available on a page for image disposal in the above example, the disposal can be made by other methods. For example, it is also possible to prepare a template and use the template for disposing the images.

The selection of the direction of disposing the images can be made from the display device 53 of the image-forming device 10, or from the input device 26 of the portable telephone 12.

(Embodiment 2)

Since the image-forming device and the portable telephone according to the second embodiment are essentially identical to those of the first embodiment shown in FIGS. 1, 2 and 5 respectively, their descriptions will not be repeated here.

A feature of the second embodiment is that, while the system transmits the data formats of the image data and the image link information stored in the RAM 25 after converting them in the first embodiment, the system in the second embodiment receives any image data that correspond to images located on lower hierarchical levels compared to the image specified on the portable telephone 12, if such images exist, even if the image data correspond to them are not stored in the RAM 25, and transmits all of them after converting their data formats respectively.

Another feature of the second embodiment is that, while the system disposes the image of the highest hierarchical level and images that are located on lower hierarchical levels compared to the image and also are related hierarchically with the image in the first embodiment, the system in the second embodiment disposes the specified image and any images that are located on lower hierarchical levels compared to the specified image and are related with said image hierarchically.

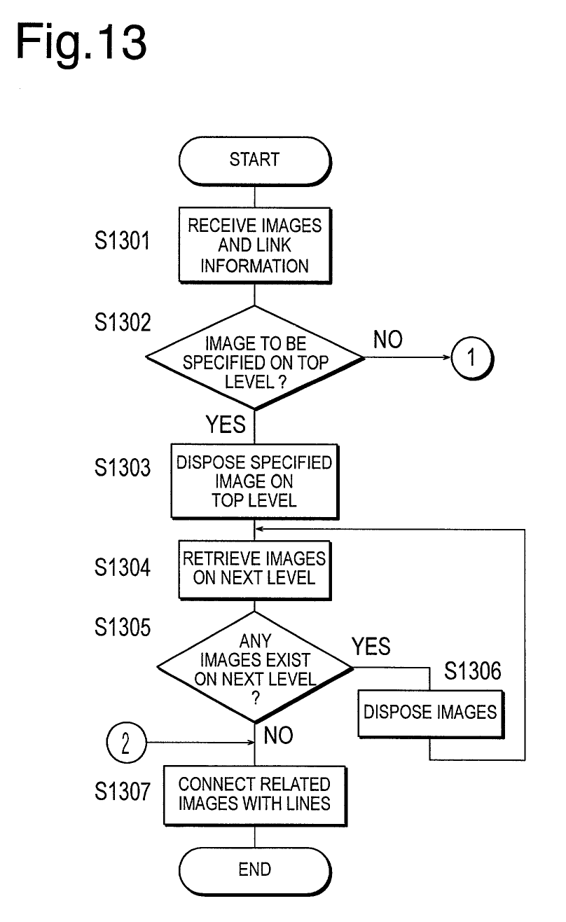

FIG. 12 is a flow chart indicating the process conducted inside the portable telephone 12 when image data are transmitted from the portable telephone 12 to the image-forming device 10.

The CPU 21 makes a judgment whether image data and image link information should be received from the database 16 in order to transmit new image data and image link information to the image-forming device 10 (S1201). The decision of whether new image data should be received is made based on a judgment of whether it has received an order for receiving new image data and image link information from the input device 26.

If new image data and image link information are to be received from the database 16 as a result of said judgment (S1201: YES), the user is to specify the image that corresponds to the image data located on the highest hierarchical level among the image data to be received (S1202). The communication device 22 will be controlled based on this specification, and will receive from the database 16 those data/information that are not stored in the RAM 25 among the image data based on the specified image, the image link information concerning the specified image, the image data that correspond to images that are hierarchically related to the specified image and located on lower hierarchical levels compared to the specified image, and the image link information concerning the specified images that are located in those lower hierarchies (S1203). The received image data and image link information will be converted into the data formats that can be processed by the image-forming device 10 (S1204), and the converted image data and image link information will be transmitted (S1205).

On the other hand, if no new image data or image link information are received from the database 16 (S1201: NO), a judgment will be made whether an image on the highest hierarchical level is specified as to image data to be transmitted to the image-forming device 10 (S1206).

If it is determined that an image located on the highest hierarchical level is specified as a result of this judgment (S1206: YES), those data/information that are stored in the RAM 25 among the image data corresponds to the specified image, the image link information concerning the specified image, the image data that correspond to images that are hierarchically related to the specified image and located on lower hierarchical levels compared to the specified image, and the image link information concerning the images that are located in those lower hierarchies will be converted into the data formats that can be processed by the image-forming device 10 (S1207), and the converted image data and image link information will be transmitted (S1205).

If, on the other hand, it is determined that no image located on the highest hierarchical level is specified as a result of this judgment (S1206: NO), the image data and image link information stored in the RAM 25 will be converted into the data formats that can be processed by the image-forming device 10 (S1208), and the converted image data and image link information will be transmitted (S1205).

Moreover, if an image located on the highest hierarchical level is specified, the information concerning the image specification will also be transmitted to the image-forming device 10 via the external interface 20.

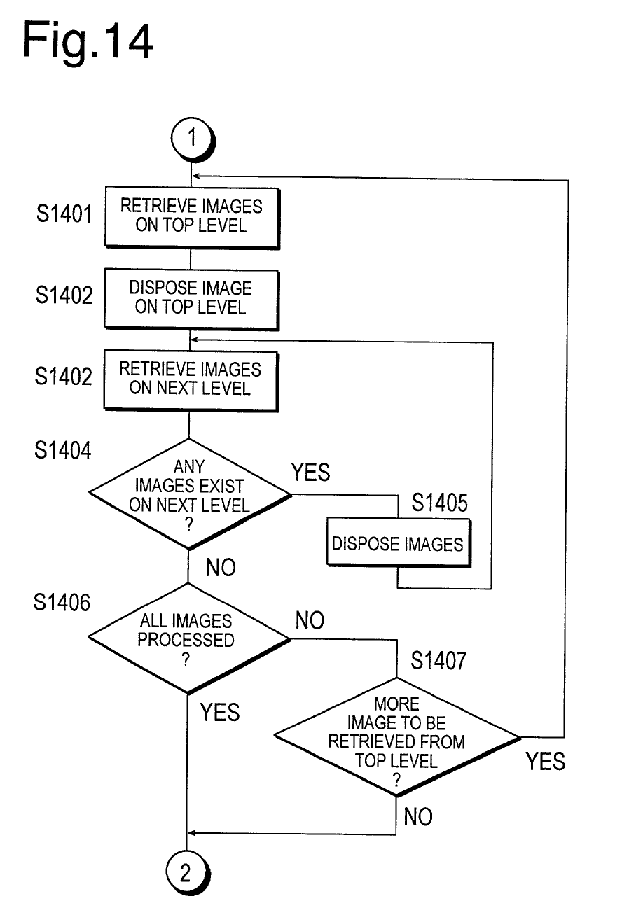

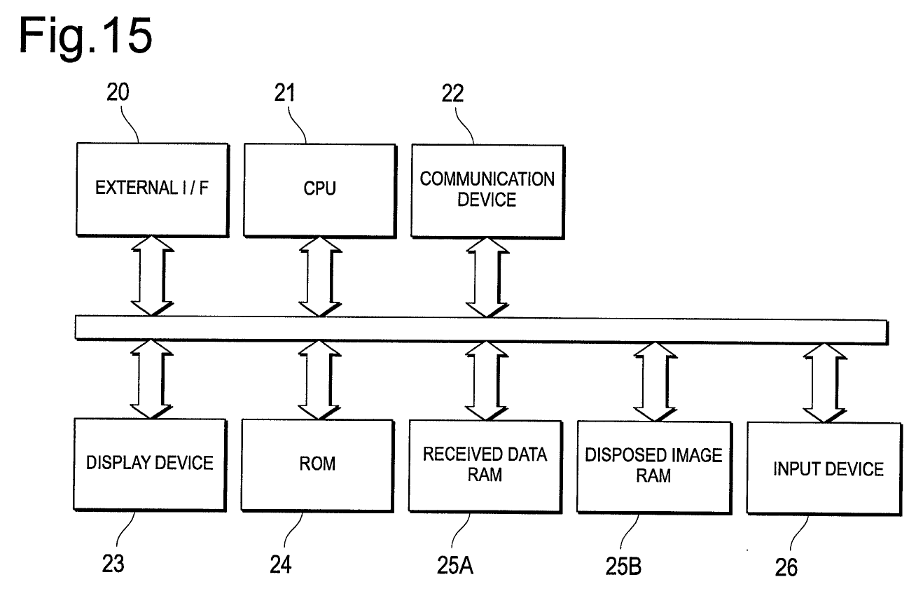

FIGS. 13 and 14 show a flow chart indicating the image disposing process performed by the image-forming device 10 when it receives image data and image link information.

The image-forming device 10 receives image data and image link information from the portable telephone 12 (S1301). The CPU 51 makes a judgment whether an image located on the highest hierarchical level is specified by the portable telephone 12 (S1302).

If it is determined that an image located on the highest hierarchical level is specified as a result of this judgment (S1302: YES), the CPU 51 disposes the specified image to a disposal location corresponding to the highest hierarchical level (S1303).

When it finishes disposing the image on the highest hierarchical level, it retrieves images located on the level of hierarchy next to the top level based on the image link information (S1304), to make a judgment whether there are any images on the next level of hierarchy (S1305). While it retrieves the presence of images that are hierarchically related to the image on the highest hierarchical level and are located on the level next to the top level at the step S1304, it will retrieve images that are hierarchically related to images located on the higher hierarchical level and are located on the next level of hierarchy during the steps that follow.

If it is determined that images exist on the next hierarchical level as a result of this judgment (S1305: YES), the images on the next hierarchical level will be disposed in the disposing place corresponding to the hierarchical level (S1306), and the system returns to the step S1304.

On the other hand, if it is determined that no images exist on the next hierarchical level as a result of this judgment (S1305: NO), those disposed images that are mutually related are connected by solid line arrows to indicate there hierarchical relations based on the image link information, and the images of those connecting lines are added to the disposed images (S1307) to complete the image disposal process.

If it is determined that no image located on the highest hierarchical level is specified as a result of the judgment at the step S1302 (S1302: NO), it retrieves an image located on the highest hierarchical level from all the images based on the received image data and the image link information (S1401). The retrieved image located on the highest hierarchical level is disposed to a disposal location corresponding to the highest hierarchical level (S1402).

When it finishes disposing the image on the highest hierarchical level, it retrieves images that are related hierarchical to the image on the highest hierarchical level and located on the level of hierarchy next to the top level based on the image link information (S1403), to make a judgment whether there are any images on the next level of hierarchy (S1404). While it retrieves the presence of images that are hierarchically related to the image on the highest hierarchical level and are located on the level next to the top level at the step S1403, it will retrieve images that are hierarchically related to images located on the higher hierarchical level and are located on the next level of hierarchy during the steps that follow.

If it is determined that images exist on the next hierarchical level as a result of this judgment (S1404: YES), the images on the next hierarchical level will be disposed in the disposing place corresponding to the hierarchical level (S1405), and the system returns to the step S1403.

If no image exists in the next level of hierarchy (S1404: NO), a judgment is made whether the process has been completed for all the images (S1406).

If it is determined that the process has been completed for all the images as a result of the judgment (S1406: YES), the system advances to the step S1307 shown in FIG. 13.

On the other hand, if the process has not been completed for all the images (S1406: NO), a judgment is made based on the image link information as to whether any images exist yet to be retrieved on the same top level of hierarchy as the image retrieved at the step S1401 (S1407).

If it is determined that another image exists on the same level of hierarchy as the image retrieved at the step S1401 (S1407: YES), the system returns to the step S1401.

If it is determined that no more image exists on the same level of hierarchy as the image retrieved at the step S1401 (S1401: NO), the system advances to the step S1307 shown in FIG. 13.

Thus, when an image located at the top level of hierarchy is specified by the portable telephone 12, the image-forming device 10 is capable of disposing the specified image as well as images located on lower hierarchical levels compared to the specified image. Moreover, if no image on the top level of hierarchy is specified, the system can perform the image disposal process similarly as the first embodiment.

Furthermore, when the portable telephone 12 receives new image data and image link information, it can convert the data formats of the image data that correspond to images, which are located on lower hierarchical levels compared to the specified image and are not stored on the RAM 25, and the data formats of the image link information concerning said images, and transmit the converted images and image link information.

In the first and second embodiments described above, the CPU 51 executing the respective programs, which contain the descriptions of the processing sequences shown in FIG. 7 as well as FIGS. 13 and 14, conducts the image disposal processes, while the CPU 21 executing the respective programs, which contain the descriptions of the processing sequences, conducts the transmission processes of the image data and the image link information. These respective programs can be provided in the form of application software recorded on computer-readable recording media (e.g., floppy disk, CD-ROM, etc.).

(Embodiment 3)

The image-forming device and the portable telephone according to the third embodiment of the present invention are applicable to an information capturing system similar to the one, to which the image-forming device and the portable telephone according to the first embodiment as shown in FIG. 1 are applied.

Since the portable telephone according to the third embodiment of the present invention has a basic composition substantially similar to that of the portable telephone according to the first embodiment as shown in FIG. 2, the same components are identified with the same number and their descriptions are not repeated here.

The feature of the third embodiment is that the portable telephone is in charge of disposing the images in contrast to the fact that the image-forming device is in charge of that in the first embodiment.

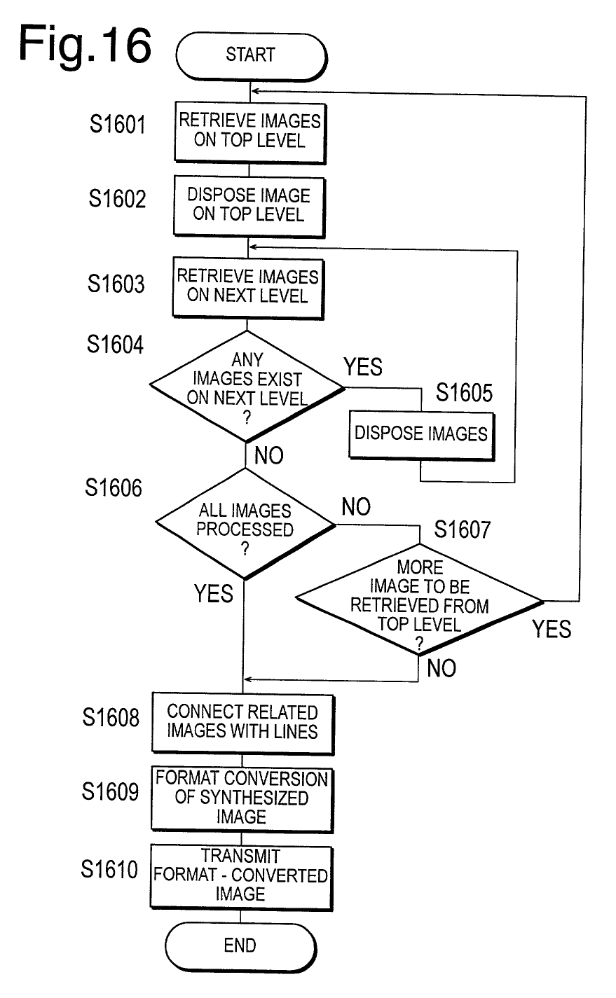

FIG. 15 is a block diagram showing the composition of the portable telephone 12.

The portable telephone 12 comprises an external interface (I/F) 20, a CPU 21, a communication device 22, a display device 23, a ROM 24, a received data RAM 25A, disposed image RAM 25B, and an input device 26.

The ROM 24 stores the control program of the portable telephone 12 and the conversion table for converting image data into a data format that can be processed by the image-forming device 10. The received data RAM 25A stores the image data and the image link information received by the communication device 22. The disposed image RAM 25B stores the images disposed according to the image link information. The input device 26 has multiple operating pushbuttons for the user to operate the portable telephone 12.

When the user wishes to receive image data from the database 16, the user selects an image that the user wishes to receive at the input device 26 while monitoring the display device 23. Based on the selection, the CPU 21 controls the communication device 22 to receive an image data that corresponds to the image and the image link information from the database 16. The received image data and the image link information are stored in the received data RAM 25A sequentially. The image based on the received image data will be displayed on the display device 23. Image examples of the display device 23 of the portable telephone 12 are similar to those shown in FIG. 3 and FIG. 4. The image is displayed for the entire width of the portable telephone 12's screen.

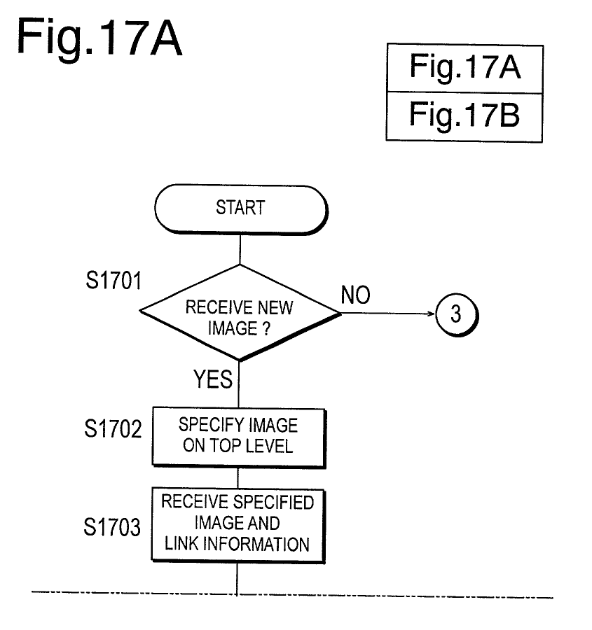

FIG. 16 is a flow chart indicating the process performed inside the portable telephone 12 when the portable telephone 12 is transmitting images to the image-forming device 10.

The CPU 21 retrieves an image that is located on the highest hierarchical level among the images stored in the received data RAM 25A based on the image link information stored in the received data RAM 25A (S1601). It then disposes the retrieved image that is located on the highest hierarchical level to a disposing location corresponding to the highest hierarchical level (e.g., the location of a block 910 shown in FIG. 9) (S1602). This disposition is performed by storing the image in the disposed image RAM 26B.

When the disposition of the image on the highest hierarchical level is finished, it then retrieves images hierarchically related to the image located on the highest hierarchical level and located on the next level of hierarchy (S1603), and makes a judgment whether there are such images on the next level of hierarchy (S1604). While the system retrieves images hierarchically related to the image located on the highest hierarchical level and located on the next level of hierarchy at the step S1603, it will retrieve images hierarchically related to the images located on the higher hierarchical level and located on the next level of hierarchy during the steps that follow.

If it is determined that there are image(s) on the next level of hierarchy as a result of the judgment (S1604: YES), the images located on the level of hierarchy will be disposed on the location(s) that correspond to said level of hierarchy (e.g., locations of the block 920 shown in FIG. 9) (S1605), and the system returns to the step S1603.

On the other hand, if no image exists in the next level of hierarchy (S1604: NO), a judgment is made whether the process has been completed for all the images (S1606).

If it is determined that the process has been completed for all the images as a result of the judgment (S1606: YES), those disposed images that are mutually related are connected with solid line arrows to indicate the hierarchical relations based on the image link information, and such an image of connecting lines is added to the disposed images to form the disposal images (S1608). The disposed image data that correspond to disposal images thus formed are converted to the data formats that can be processed by the image-forming device 10 (S1609). The disposed image data, after having the data formats converted, will be transmitted to the image-forming device 10 (S1610). The disposed images date that are transmitted are then bitmap-developed by the image-forming device 10 as shown in FIG. 8.

On the other hand, if the process has not been completed for all the images (S1606: NO), a judgment is made based on the image link information as to whether any images exist yet to be retrieved on the same top level of hierarchy as the image retrieved at the step S1601 (S1607).

If it is determined that another image exists on the same level of hierarchy as the image retrieved at the step S1601 (S1607: YES), the system returns to the step S1601.

If it is determined that no more image exists on the same level of hierarchy as the image retrieved at the step S1601 (S1607: NO), the processes of the steps S1608 through the step S1610 will be performed.

In the examples of image disposals by the portable telephone 12 described in the above, the images of different levels of hierarchy are disposed horizontally from left to right in sequence. However, the direction of image disposal can be arbitrarily selected, either horizontal or vertical as described in the first embodiment as shown in FIGS. 9, 10 and 11.

(Embodiment 4)

Since the portable telephone for the fourth embodiment of the present invention has a basic composition identical to the portable telephone for the third embodiment shown in FIG. 15, its description is not repeated here.

The feature of the fourth embodiment is that, in contrast to the third embodiment where images are disposed based on the image data and the image link information stored in the received data RAM 25A, the system is capable of specifying images on the portable telephone 12, receiving image data correspond to images on a lower level of hierarchy if such images exist on the level lower than that of the specified image, and disposing the images including the received ones.

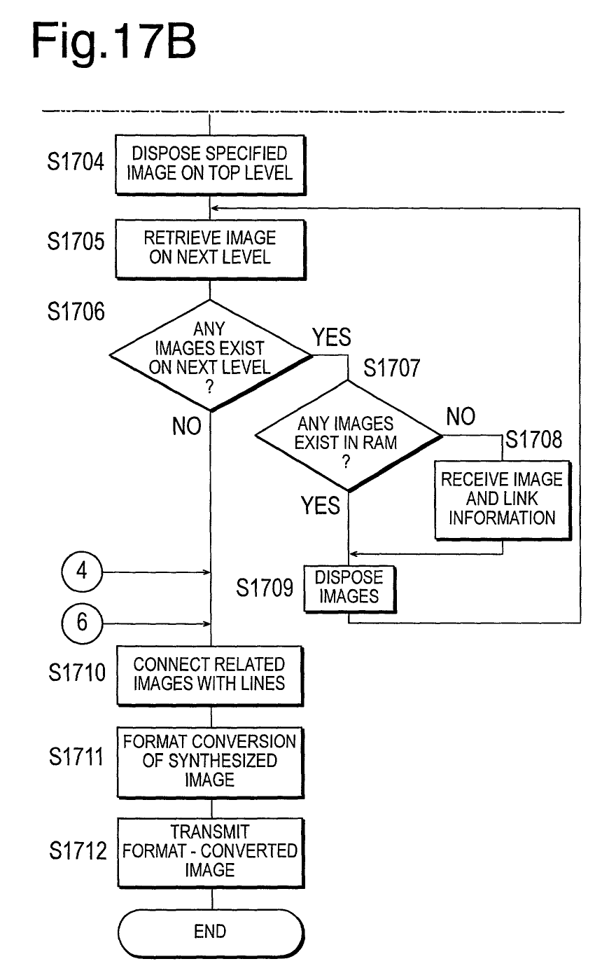

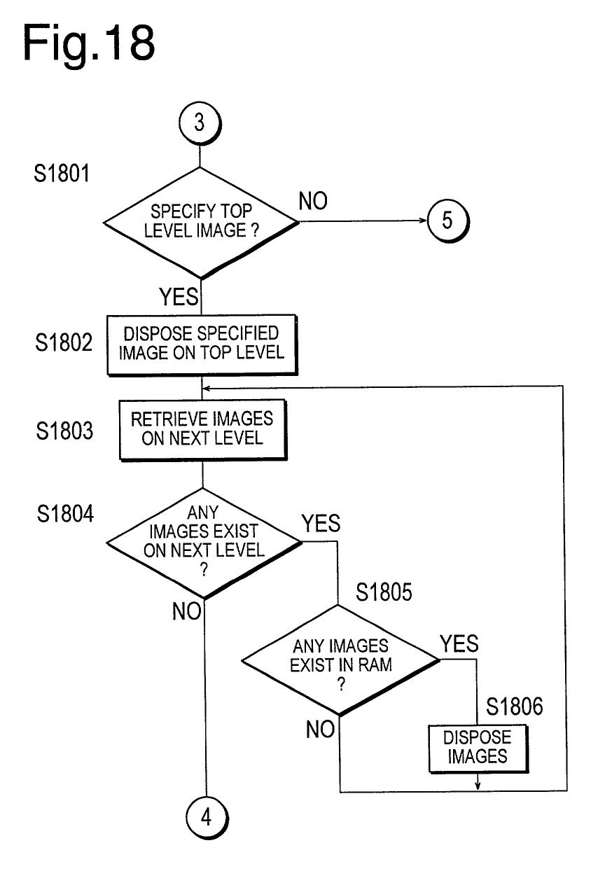

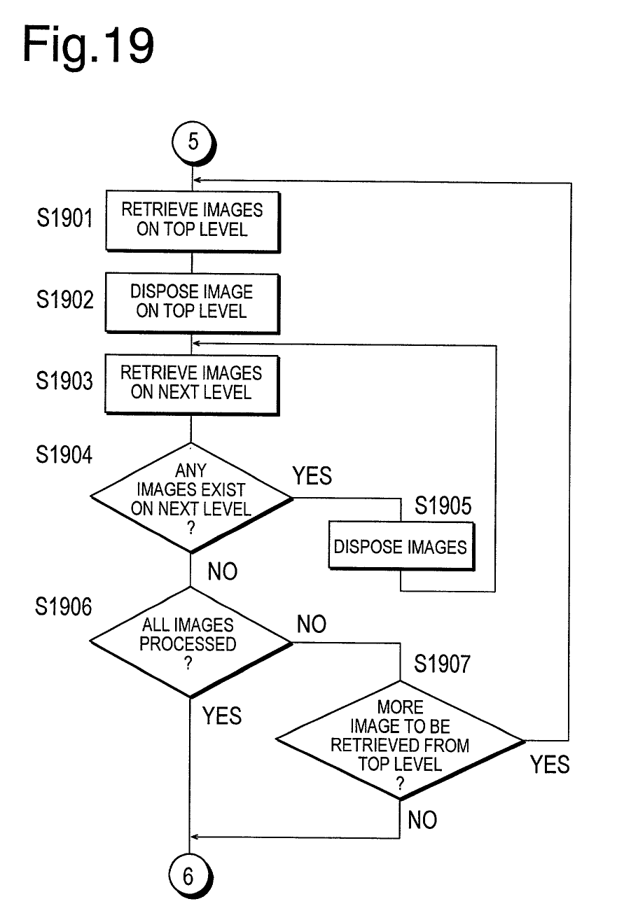

FIGS. 17A, 17B, 18 and 19 are flow charts indicating the processes within the portable telephone 12 when the portable telephone 12 transmits image data to the image-forming device 10.

The CPU 21 makes a judgment whether image data and image link information should be received from the database 16 in order to transmit new image data and image link information to the image-forming device 10 (S1701). The decision of whether new image data should be received is made based on a judgment of whether it has received an order for receiving new image data and image link information from the input device 26.

If it is determined that new image data and image link information are to be received from the database 16 as a result of said judgment (S1701: YES), the user is to specify the image that corresponds to the image data located on the highest hierarchical level among the image data to be received (S1702). The communication device 22 will be controlled based on this specification, and will receive the image data that correspond to the specified image and the image link information concerning the specified image from the database 16 (S1703). The received image will be disposed to a disposal location corresponding to the top level of hierarchy (S1704).

When it finishes disposing the image on the highest hierarchical level, it retrieves images located on the level of hierarchy next to the top level based on the image link information (S1705), to make a judgment whether there are any images on the next level of hierarchy (S1706). While it retrieves the presence of images that are hierarchically related to the image on the highest hierarchical level and are located on the level next to the top level at the step S1705, it will retrieve images that are hierarchically related to images located on the higher hierarchical level and are located on the next level of hierarchy during the steps that follow.

If it is determined that images exist on the next hierarchical level as a result of this judgment (S1706: YES), a judgment is made whether the image data corresponding to the images located on the next level of hierarchy and the image link information for the images are stored in the received data RAM 25A (S1707).

If the image data corresponding to the images located on the next level of hierarchy and the image link information of the images are stored in the received data RAM 25A (S1707: YES), the images on the level of hierarchy will be disposed within the disposal location corresponding to the level of hierarchy (S1709), and the system returns to the step S1705.

On the other hand, if the image data corresponding to the images located on the next level of hierarchy and the image link information of said images are not stored in the received data RAM 25A (S1707: NO), the communication device 22 is controlled to receive the image data corresponding to the images located on said level of hierarchy and the image link information of the images from the database 16 (S1708), the images located on said level of hierarchy are disposed in disposing locations corresponding to the level (S1709), and the system returns to S1705.

Also, if no images exist on the next hierarchical level as a result of the judgment of the step S1706 (S1706: NO), those disposed images that are mutually related are connected by solid line arrows to indicate there hierarchical relations based on the image link information, and the images of those connecting lines are added to the disposed images (S1710) to form the disposal images. The disposed image data that correspond to the disposal images thus formed are converted into data formats that can be processed by the image-forming device 10 (S1711). The disposed image data will be transmitted to the image-forming device 10 after the data formats have been converted (S1712).

If it is determined that no new image data and image link information are to be received from the database 16 as a result of said judgment at the step S1701 (S1701: NO), a judgment is made whether an image located on the top level of hierarchy is specified as to the image to be transmitted to the image-forming device 10 (S1801).

If it is determined that an image located on the top level of hierarchy is specified as a result of this judgment (S1801: YES), the specified image will be disposed to a disposal location corresponding to the top level of hierarchy (S1802).

When it finishes disposing the image on the highest hierarchical level, it retrieves images located on the level of hierarchy next to said top level based on the image link information (S1803), to make a judgment whether there are any images on the next level of hierarchy (S1804). While it retrieves the presence of images that are hierarchically related to the image on the highest hierarchical level and are located on the level next to the top level at the step S1803, it will retrieve images that are hierarchically related to images located on the higher hierarchical level and are located on the next level of hierarchy during the steps that follow.

If it is determined that images exist on the next hierarchical level as a result of this judgment (S1804: YES), a judgment is made whether the image data corresponding to the images located on the next level of hierarchy and the image link information for said images are stored in the received data RAM 25A (S1805).

If the image data corresponding to the images located on the next level of hierarchy and the image link information of the images are stored in the received data RAM 25A (S1805: YES), the images on the level of hierarchy will be disposed within the disposal location corresponding to the level of hierarchy (S1806), and the system returns to the step S1803.

On the other hand, if the image data corresponding to the images located on the next level of hierarchy and the image link information of the images are not stored in the received data RAM25A (S1805:NO), the system returns to S1803.

If it is determined that no image exists on the next hierarchical level as a result of the judgment at the step S1804 (S1804: NO), the system advances to the step S1710 shown in FIG. 17B, and the disposed image data corresponding to the disposal images, which are formed by correlating the disposed images, are converted to data formats that can be processed by the image-forming device 10, and transmitted.

If it is determined that no image located on the top level of hierarchy is specified as a result of the judgment S1801 (S1801: NO), an image located on the top level of hierarchy is retrieved among the images that correspond to the image data stored in the received data RAM 25A based on the image data and the image link information stored in the received data RAM 25A (S1901). The retrieved image that is located on the top level of hierarchy will be disposed on a disposal location corresponding to the top level of hierarchy (S1902).

When it finishes disposing the image on the highest hierarchical level, it retrieves images located on the level of hierarchy next to the top level based on the image link information (S1903), to make a judgment whether there are any images on the next level of hierarchy (S1904). While it retrieves the presence of images that are hierarchically related to the image on the highest hierarchical level and are located on the level next to the top level at the step S1903, it will retrieve images that are hierarchically related to images located on the higher hierarchical level and are located on the next level of hierarchy during the steps that follow.

If it is determined that images exist on the next hierarchical level as a result of this judgment (S1904: YES), the images on the next hierarchical level will be disposed in the disposing place corresponding to the hierarchical level (S1905), and the system returns to the step S1903. If no image exists in the next level of hierarchy (S1904: NO), a judgment is made whether the process has been completed for all the images (S1906).

If it is determined that the process has been completed for all the images as a result of the judgment (S1906: YES), the system advances to the step S1710 shown in FIG. 17B, and the disposed image data corresponding to the disposal images, which are formed by correlating the disposed images, are converted to data formats that can be processed by the image-forming device 10, and transmitted.

On the other hand, if the process has not been completed for all the images (S1906: NO), a judgment is made based on the image link information as to whether any images exist yet to be retrieved on the same top level of hierarchy as the image retrieved at the step S1901 (S1907).

If it is determined that another image exists on the same level of hierarchy as the image retrieved at the step S1901 (S1907: YES), the system returns to the step S1901.

On the other hand, if it is determined that no image exists on the same level of hierarchy as the image retrieved at the step S1901 (S1907: NO), the system advances to the step S1710 shown in FIG. 17B, and the disposed image data corresponding to the disposal images, which are formed by correlating the disposed images, are converted to data formats that can be processed by the image-forming device 10, and transmitted.

Thus, when the portable telephone 12 is to receive new image data and the image link information, it is capable of receiving the data of the image that are located on lower levels of hierarchy compared to the specified image and are not stored in the received data RAM 25A as well as the image link information related to the image and disposing the images. Moreover, if it is not to receive any new image data and related image link information, it is capable of disposing the images that are located on lower levels of hierarchy compared to the specified image and are stored in the received data RAM 25A.

If there is no image is specified, it performs the same image disposal process as in the third embodiment.

In the third and fourth embodiments described above, the CPU 21 executing the respective programs, which contain the descriptions of the processing sequences shown in FIGS. 16, 17, 18 and 19, conducts the image disposal processes. These respective programs can be provided in the form of application software recorded on computer-readable recording media (e.g., floppy disk, CD-ROM, etc.).

Although solid line arrows are used in the images to indicate the hierarchical relations between the disposed images in the steps S709, S1307, S1608 and S1710, the present invention is not limited to said practice. Such hierarchical relations of the disposed images can be indicated using arbitrary types of lines, arrows, or graphics such as triangles, characters and numbers.

For example, if numbers are to be used, it is possible to indicate hierarchical relations by assigning 1 to the image on the top level of hierarchy, 1-1 and 1-2 to the images on the next level of hierarchy, and 1-1-1 and 1-1-2 to the images that are located on the next level down and related to the image assigned with 1-1.

It is also possible to add an image containing the same graphics or symbols to each of the related images. The portable telephone used in the embodiments described above can be replaced with other devices equipped with a display unit using a hierarchical menu such as a PHS telephone, a pager, and a PDA (personal electronic equipment such as an electronic pocket book).

As can be seen from the description above, the present invention provides means of disposing images hierarchically correlated to an image data received on a portable telephone based on the correlating information indicating the hierarchical correlation of the image data. In other words, the user can view the images belonging to different hierarchical levels all at once as they are outputted in an array disposed to indicate their relations.

Specifically, the user can view arbitrary images belonging to different hierarchical levels simultaneously based on the user's instruction, as the system disposes the images that are located on lower levels compared to and related to an image specified by the user from the received images.

The computer program product mentioned in the claims contains the program itself, memory media storing the program, and devices that operate on the installed program.

The entire disclosures of the Japanese Patent Application Nos. 2,000-60655 filed on Mar. 6, 2000 and 2,000-60656 filed on Mar. 6, 2000 including their specifications, claims and summaries are incorporated herein by reference in their entireties.

What is claimed is:

1. Image-forming device comprising:
a receiving unit that receives image data corresponding to multiple images as well as information indicating relations between the images from a portable telephone;
an image processing unit that disposes the multiple images based on received information; and
a printing unit that prints images disposed by the image processing unit.

2. Image-forming device of claim 1 wherein said images are displayed for the entire width of the portable telephone's screen respectively.

3. Image-forming device of claim 1 wherein said image processing unit adds line drawing images that indicate relations of the multiple images.

4. Image-forming device of claim 1 further comprising a selection unit that selects different formats for disposing the multiple images.

5. Image-forming device of claim 4 wherein the formats that can be selected by said selection unit include vertical formats and horizontal formats.

6. Image-forming device of claim 1 wherein said relations are hierarchical relations.

7. Image-forming device of claim 6 further comprising a specifying unit that specifies one image from images corresponding to the received image data, wherein said image processing unit disposes the specified image as well as images that belong to lower levels of hierarchy compared to the specified image.

8. Portable telephone comprising:
a memory unit that stores image data corresponding to multiple images and information indicating relations between the images; and
an output unit that outputs the stored image data corresponding to multiple images and the information indicating relations between the images.

9. Portable telephone of claim 8 wherein said images are displayed for the entire width of the portable telephone's screen respectively.

10. Portable telephone of claim 8 wherein said relations are hierarchical relations.

11. Image processing device comprising:
a receiving unit that receives image data corresponding to multiple images as well as information indicating relations between the images from a portable telephone;
an image processing unit that disposes the multiple images based on received information; and
an output unit that outputs image data corresponding to the images that have been disposed by said image processing unit.

12. Image processing device of claim 11 wherein said images are displayed for the entire width of the portable telephone's screen respectively.

13. Image processing device of claim 11 wherein said image processing unit adds line drawing images that indicate relations of the multiple images.

14. Image processing device of claim 11 wherein said relations are hierarchical relations.

15. Image processing method comprising the steps of:
receiving image data corresponding to multiple images as well as information indicating relations between the images from a portable telephone;
disposing the multiple images based on received information; and
outputting image data corresponding to the images that have been disposed.

16. Image processing method of claim 15 further comprising the steps of printing images on paper based on the image data outputted by the output unit.

17. Image processing method of claim 15 wherein said images are displayed for the entire width of the portable telephone's screen respectively.

18. Image processing method of claim 15 wherein said relations are hierarchical relations.

19. Image processing method comprising the steps of:
receiving image data corresponding to multiple images as well as information indicating relations between the images from a portable telephone;
disposing the multiple images based on received information;
adding line drawing images indicating relations between the images that have been disposed; and
outputting image data corresponding to the images that have been disposed as well as the line drawing images.

20. Computer program product, executing the procedures of:
receiving image data corresponding to multiple images as well as information indicating relations between the images from a portable telephone;
disposing the multiple images based on received information; and
outputting image data corresponding to the images that have been disposed.
